(19) United States
(12) Patent Application Publication
(10) Pub. No.: US 2016/0229224 A1
(43) Pub. Date: Aug. 11, 2016

(54) COVER FOR A WET PAINT ROLLER

(71) Applicant: William Lester, III, Miami, FL (US)

(72) Inventor: William Lester, III, Miami, FL (US)

(21) Appl. No.: 14/617,884

(22) Filed: Feb. 9, 2015

(51) Int. Cl. B44D 3/12; B65D 55/16

(52) U.S. Cl. CPC B44D 3/125; B65D 55/16

(57) ABSTRACT

A case for storing a paint roller comprising a cylindrical case element including means for opening the case element and adapted for enclosing a paint roller attached to a roller tool. The case includes a circular opening in one end of the cylindrical case element, the circular opening adapted to allow a roller tool to extend from the case element when in a closed position, and the circular opening further adapted to allow removal of the roller tool from the case element in the closed position, while allowing the paint roller to remain within the case element. The case includes a solid cap for closing the circular opening when the case element is in the closed position and encloses solely a paint roller. The case includes a slotted cap for closing the circular opening when the case element is in the closed position.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to the field of painting, and more specifically to the field of paint rollers.

### BACKGROUND

Individuals throughout the world apply or spread paint or other substances (herein referred to as “paint”) on a variety of surfaces for numerous reasons. Paint can be used for beatification of a variety of surfaces. In addition paint can be used for a variety of functional reasons, such as for sealing, staining, priming, etc. Further, paint can be applied or spread onto surfaces using brushes, sprayers or rollers.

For surfaces having a larger area, it is well known to one of ordinary skill in the art to use a roller tool as the preferred method of applying or spreading paint onto the surface. A roller tool generally comprises a roller movably attached by a wire arm to a roller handle. The roller is cylindrical and comprises fabric or sponge like material. To use a rolling tool, an individual applies paint to the body of the roller and then uses the handle to roll the tool onto a surface in order to spread or apply such paint to a surface. Using a rolling tool allows an individual to cover a large area of surface in a shorter amount of time as compared to a brush, because rollers are capable of retaining a significant amount of paint since the material forming a roller allows them to do so.

However, there are disadvantages to using a rolling tool and roller to apply or spread paint onto surfaces. One such disadvantage occurs when an individual requires an intermission from painting. If left in an open air environment, during an intermission from painting, the air begins to dry the paint on the roller. Because of this drying effect, the paint may become unusable after an intermission, thereby creating wasted paint. In many cases, individuals are required to spend time cleaning the roller before taking an intermission from painting so that the roller is not destroyed when paint dries on the roller. When individuals take time to clean the roller before taking an intermission work, time is wasted, thereby creating inefficiencies. Further, if left in an open air environment during an intermission from painting, a wet paint roller can cause messy leaks from paint and other liquids on the paint roller.

As a result, there exists a need for improvements over the prior art and more particularly for a more efficient way of painting using a roller and preventing wasted paint and lost time due to clean up.

### SUMMARY

A case for storing a wet paint roller is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a case for storing a paint roller is disclosed. The case comprises a cylindrical case element including means for opening the case element and adapted for enclosing a paint roller attached to a roller tool. The case includes a circular opening in one end of the cylindrical case element, the circular opening adapted to allow a roller tool to extend from the case element when in a closed position, and the circular opening further adapted to allow removal of the roller tool from the case element in the closed position, while allowing the paint roller to remain within the case element. The case further includes a solid cap for closing the circular opening when the case element is in the closed position and encloses solely a paint roller. The case further includes a slotted cap for closing the circular opening when the case element is in the closed position.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a front perspective view of a case for storing a paint roller in a fully assembled closed position, according to one embodiment;

FIG. 2 is a rear perspective view of the case in a fully assembled closed position, according to one embodiment;

FIG. 3 is a front perspective view of the case in a fully assembled closed position, according to one embodiment;

FIG. 4 are front perspective views of the case in a fully assembled open position and a paint roller, according to one embodiment;

FIG. 5 is a front perspective view of a paint roller stored inside the case in a fully assembled closed position, according to one embodiment;

FIG. 6 is a front perspective view of a paint roller stored inside the case in a closed position, according to one embodiment;

FIG. 6B is a cross sectional view of a paint roller stored inside the case in a closed position, according to one embodiment;

FIG. 7 is a front perspective view of a rolling tool outside the case in a closed position, according to one embodiment;

FIG. 8 is a front perspective view of a paint roller stored inside the case in an open position, according to one embodiment;

FIG. 9 is a top view of a paint roller stored inside the case in an open position, according to one embodiment;

FIG. 10 is a front perspective view of a paint roller outside the case in an open position, according to one embodiment;

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a case for storing a wet paint roller when not in use. When in the closed position and substantially hermetically sealed, the case can reduce or eliminate the need for cleaning the roller before taking an intermission from painting with a roller. Additionally, the case can decrease the amount of paint used because paint may not have to be removed from a roller and thereby wasted before taking an intermission from painting. Additionally, when substantially hermetically sealed, the case can maintain the roller wet, thereby allowing for faster return to work after an intermission, thereby creating a more efficient use of time. Lastly, the hermetic seal provided by the case eliminates or reduces messy leaks or smears that could results from handling a wet paint roller, thereby facilitating handling of the roller.

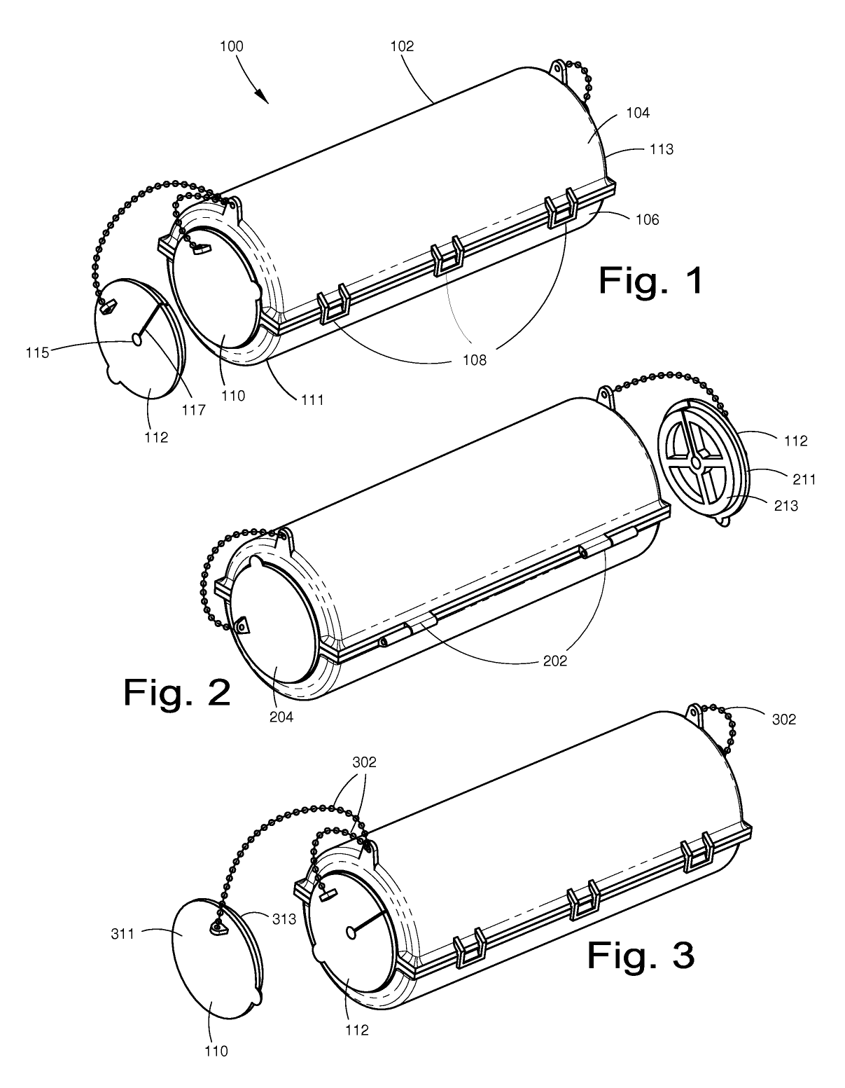

Referring now to the Figures, FIG. 1 is a front perspective view of a case assembly 100 for storing a paint roller in a fully assembled closed position, according to one embodiment. The case is for storing a wet paint roller so as to maintain the paint roller wet. The case comprises a cylinder or case element 102 having a first section or bottom portion 106 hingedly connected to a second section or top portion 104. In other embodiments, the first and second sections can be detachably connected or include means so as to allow access to the inner volume of the case element. In one embodiment, the first section comprises a half tube shaped body and the second section comprises a half tube shaped body such that when in a closed position the case element defines a tubular or cylindrical shaped body having a first end 111 opposing a second end 113.

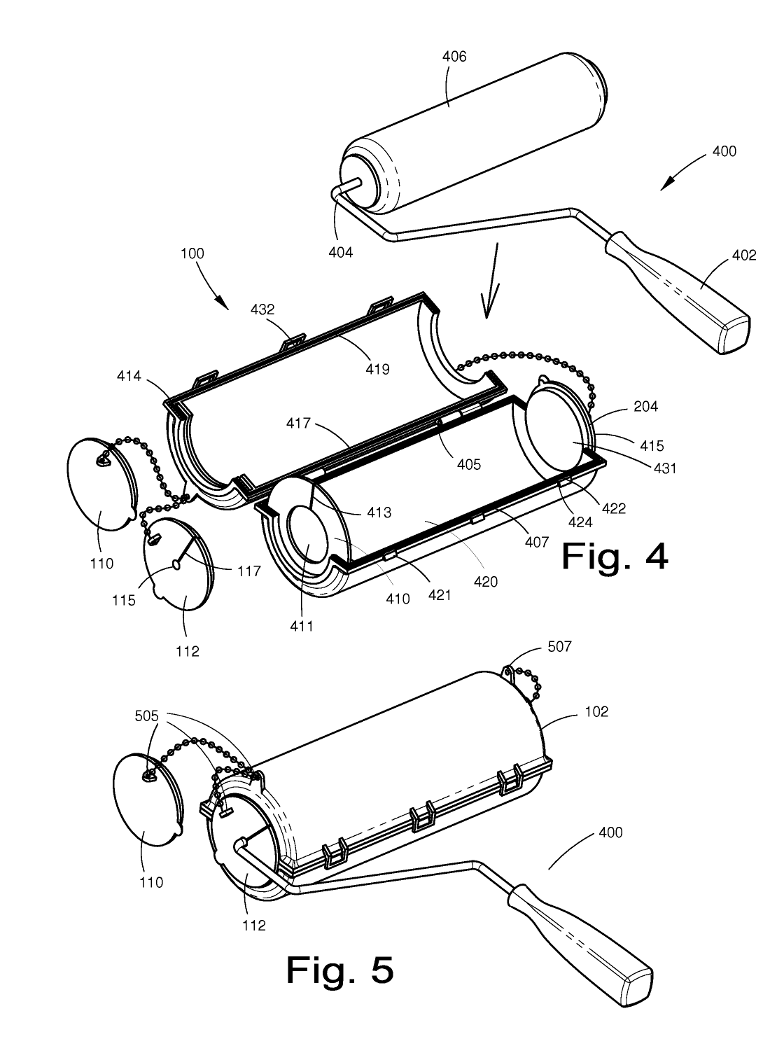

The tubular shape of the case element defines an inner volume (illustrated as 420 in FIG. 4) that is adapted for allowing access and receiving a paint roller when the case is in an open position and that is adapted for enclosing a paint roller attached to a roller tool when the case element is in the closed position (as illustrated in FIG. 5). At least one end of the case element has a circular opening. The circular opening is adapted to allow a roller tool to extend from the case element in a closed position (as illustrated in FIG. 5). FIG. 1 also illustrates fasteners 108 for closing and locking the top and bottom portions of the case element when the case element is in a closed position (more fully explained below).

FIG. 2 is a rear perspective view of the case in a fully assembled closed position, according to one embodiment. FIG. 2 illustrates a plurality of hinges 202 hingedly connecting the bottom portion or first section 106 with the top portion or second section 104. Such hinges and hinged connections are well known to those skilled in the art. However, other means of connecting the top and bottom portions may also be used and are within the scope of the invention and the disclosed hinged mechanism is not meant to be a limitation.

The case assembly also includes a slotted cap or disc 112 for closing the opening of the first end of the case element when the case element is in the closed position while allowing the roller tool to extend from the case element. The slotted cap allows the inner volume of the case element to be substantially hermetically sealed when the case element is in the closed position. The hermetic seal provided by the case eliminates or reduces messy leaks or smears that could results from paint or other liquids on a wet paint roller. The term “substantially hermetically sealing” refers to a hermetic seal, a near hermetic seal or a seal that completely or substantially reduces the flow of air and/or water through said seal.

The disc or slotted cap 112 can comprise a first cylindrical body 211 (shaped like a disc, for example) comprising a material having rigid properties (such as rigid plastic) and comprising a top surface or outward facing surface opposing a bottom surface or inward facing surface, and a second cylindrical body 213 (shaped like a disc, for example) comprising a material having resilient properties (such as rubber) and coupled to the bottom surface of the first cylindrical body. The second cylindrical body of the slotted end cap is adapted to be inserted into and to plug the opening of the first end of the case element when the case element is in the closed position.

The first and second cylindrical bodies of the slotted end cap 112 or disc have a central aperture 115 and a slit or slot 117 spanning from the aperture to a position on the perimeter of the disc. The slit is adapted for allowing an arm of a rolling tool to be pushed through the slit and end up in the aperture 115. The aperture 115 is adapted for allowing the arm of the rolling tool to extend through cap 112 when the case element is in the closed position.

FIG. 3 illustrates the solid first end cap 110. The first end cap is adapted for closing or plugging the first end 111 of the case element and for substantially hermetically sealing the inner volume of the case element. In the present embodiment, the first end cap 110 comprises a first cylindrical planar body 311 (shaped like a disc, for example) comprising a material having rigid properties (such as rigid plastic) and comprising a top surface or outward facing surface opposing a bottom or inward facing surface. A second cylindrical body 313 (shaped like a disc, for example) comprising a material having resilient properties (such as rubber) is coupled to the bottom surface of the first cylindrical body. The second cylindrical body extends from the bottom surface of the first cylindrical body and can have a diameter that is adapted to be inserted into and plug the opening of the first end of the case element when the case element is in a closed position.

As shown in FIGS. 4 and 5, in operation, the rolling tool can be inserted into the bottom portion or first section 106 of the case element. Next, the slot or slit 117 of the slotted cap can be positioned so that the wire arm 404 of the rolling tool can pass into the centrally located aperture 115. Next, after the wire arm is received by the centrally located aperture, inward force can be applied to the slotted cap or disc so as to plug the opening of the first end of the case element and to substantially hermetically seal the inner volume of the case element.

FIG. 4 also illustrates the solid second end cap 204, similar to the first end cap, may also be adapted for closing or plugging the opening in the second end of the case element and for substantially hermetically sealing the inner volume of the case element. In the present embodiment, the second end cap 204 (more fully illustrated in FIG. 4) comprises a first cylindrical planar body 415 comprising a material having rigid properties and comprising a top surface or outward facing surface opposing a bottom or inward facing surface. A second cylindrical body 431 comprising a material having resilient properties is coupled to the bottom surface of the first cylindrical body. The second cylindrical body extends from the bottom surface of the first cylindrical body and can have a diameter that is adapted to be inserted into and plug the opening of the second end of the case element when the case element is in a closed position.

FIG. 4 also illustrates the ring 410 of the case assembly. The ring has a planar cylindrical body defining an aperture 411 and having a slit 413 spanning from a position on the perimeter of the body of the ring to the ring aperture. The ring is adapted to be received by a groove 414 or slot along portions 104 and 106 of the body of the case element. The slit of the ring is adapted for allowing a wire arm 404 of a rolling tool 400 to pass through the slit 413 into the ring aperture 411.

As illustrated in FIG. 4, in operation, the slit of the ring is positioned so that when the roller is to be positioned into the bottom portion or first section 106 of the case element, the wire arm can pass through the slit or slot on body of the ring allowing the roller to be positioned into the bottom portion of the case element. The ring aperture 411 is adapted for allowing the rolling tool to be pulled out of the case element while retaining the roller 406 of the rolling tool inside the case element 102 when the case element is in the closed position (more fully explained below).

FIG. 4 more fully illustrates one embodiment of a plurality of fasteners for locking or fastening the top and bottom portions of the case element together. In the present embodiment the bottom portion or first section 106 of the case element further defines a first side edge 405 opposing a second side edge 407. Similarly, the body of the top portion or second section 104 of the case element further defines a first side edge 417 opposing a second side edge 419. The first side edges are hingedly connected by the hinges 202, and wherein the second side edges comprise a locking device for coupling or locking the second side edges to each other.

In the present embodiment, the locking device includes three wedge shaped bodies 421 spaced along the second side edge of the bottom portion of the case element. Each of the wedge shaped bodies align with a u-shaped body 432 on the second side edge of the top portion of the case element, wherein each u-shaped body is adapted for catching and retaining a corresponding wedge so as to maintain the case element in the closed position. Each u-shaped body comprises somewhat resilient properties that allow each u-shaped body to move outward when an outward force acts on it and that allow each u-shaped body to return to its original shape when such outward force is removed. Each wedge shaped body extends outward from the body of the case element defining a flat portion 424 and an inclined portion 422.

As the case element is moved from its open position to its closed position, the inclined portion applies a substantially outward force on each of the u-shaped bodies causing the somewhat resilient u-shaped bodies to move outward. As the u-shaped bodies clears the inclined section 422 of each of the u-shaped bodies, the outward force is removed and each of the u-shaped bodies move back to their original shape. As each of the u-shaped bodies moves back into their original shape, the flat portion 424 of the wedge acts a stop and maintains each u-shaped body on each of the corresponding wedges and maintains the case element in the closed position. When in the closed position, and the openings of each end of the case are plugged, the case is significantly air tight or hermetically sealed. Additionally, when a wet roller is positioned inside the interior 420 of the cylinder or tubular shaped body and the ends are plugged, the hermetical seal of the case facilitates to maintain the roller wet. This increases the amount of time that an individual can leave a wet roller unattended without the paint on the roller drying and thus decreasing waste. Further, the hermetic seal eliminates or reduces messy leaks due to paint or other liquids on the wet paint roller.

To unlock or open the case element, outward force is applied to each of the u-shaped bodies, or alternatively an inward force is applied to the somewhat resilient wedges, which allows the u-shaped bodies to clear each of the flat sections of the wedges allowing the case element to move from the closed position to the open position.

The top and bottom portions of the case element, as well as the outward facing or first cylindrical bodies of the first end cap, second end cap, disc, and ring may comprise a rigid material. Such rigid material may comprise material such as a ferrous material, a non-ferrous material, polyethylene, wood or any combinations thereof. The components of the case assembly having resilient properties may comprise material such as polyethylene or a rubber type material and are well known to those skilled to the art. Additionally, sealing type bodies or o-rings may be used to facilitate the sealing of the case element when the case element is in the closed or locked position.

Also illustrated in FIG. 5 are that the bodies of the first 110 and second 204 caps as well as the disc or slotted cap 112 may each optionally comprise an eyelet 505 protruding from the outward facing surface and be coupled, via a metal or plastic beaded chain or chord 302 to an eyelet 507 protruding from the surface of a portion of the case element.

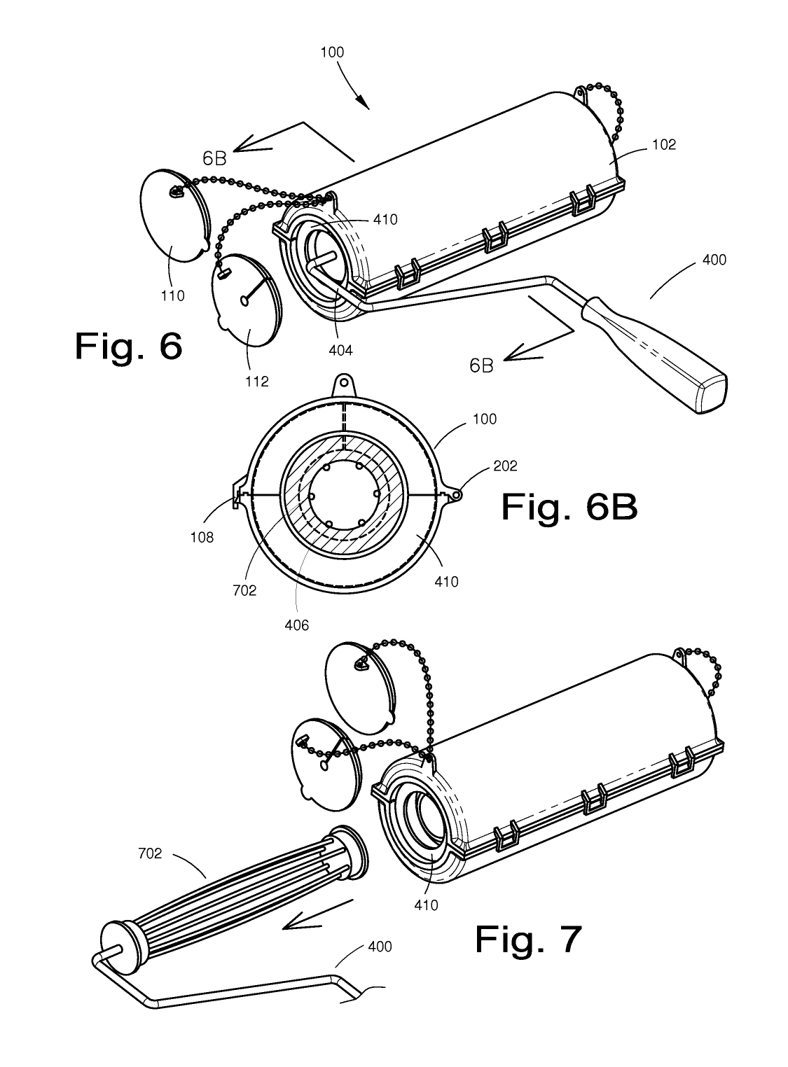

FIG. 6 is a front perspective view of a paint roller stored inside the case in a closed position, according to one embodiment. Similar to FIG. 5, FIG. 6 shows the roller tool 400 with the attached paint roller 406 enclosed in the case element 102, as the arm 404 of the roller tool extends out of the opening in the case element 102. FIG. 6, however, that the slotted cap 112 has been removed from the opening so as to allow the roller tool to be removed from the paint roller 406. The arrows indicated as 6B in FIG. 6 shows where the cross-section of FIG. 6B is taken. Thus, FIG. 6 shows the state of the system when the paint roller has been inserted into the case and either 1) the roller tool is about to be removed from the paint roller so the paint roller can be stored on its own, or 2) the roller tool will remain attached to the paint roller so the roller tool and the paint roller can be stored together. If the roller tool is removed from the paint roller so the paint roller can be stored on its own, then the case element is capped or sealed using cap 110. If the roller tool remains attached to the paint roller so the two can be stored together, then the case element is capped or sealed using cap 112. Storage of a wet paint roller inside the case element maintains the roller wet (thereby reducing wasted paint and wasted rollers) and reduces messy leaks from wet paint.

FIG. 6B is a cross sectional view of a paint roller stored inside the case in a closed position, according to one embodiment. FIG. 6B shows that the cross section depicts the hinges 202 and the fasteners 108 of the case element 102. FIG. 6B also shows the flat ring or slotted ring 410, which is located in a slot in the case element 102. FIG. 6B also shows the paint roller 406 within the inner volume of the case element 102. Specifically, the outer diameter of the paint roller 406 is greater than the diameter of the aperture in the flat ring or slotted ring 410. But the outer diameter of the roller wheel 702 is smaller than the diameter of the aperture in the flat ring or slotted ring 410. This allows the roller wheel 702 to be removed from the inner volume of the case element 102 while the paint roller 406 remains within the inner volume of the case element 102. Specifically, when the arrangement of FIG. 6 is applied, the roller wheel 702 may be pulled outwards to be removed from the inner volume of the case element 102 while the paint roller 406 remains within the inner volume of the case element 102, as it is kept in place by the flat ring or slotted ring 410. This results in the arrangement as shown in FIG. 7, wherein the roller wheel 702 has been removed from the inner volume of the case element 102 while the paint roller 406 remains within the inner volume of the case element 102.

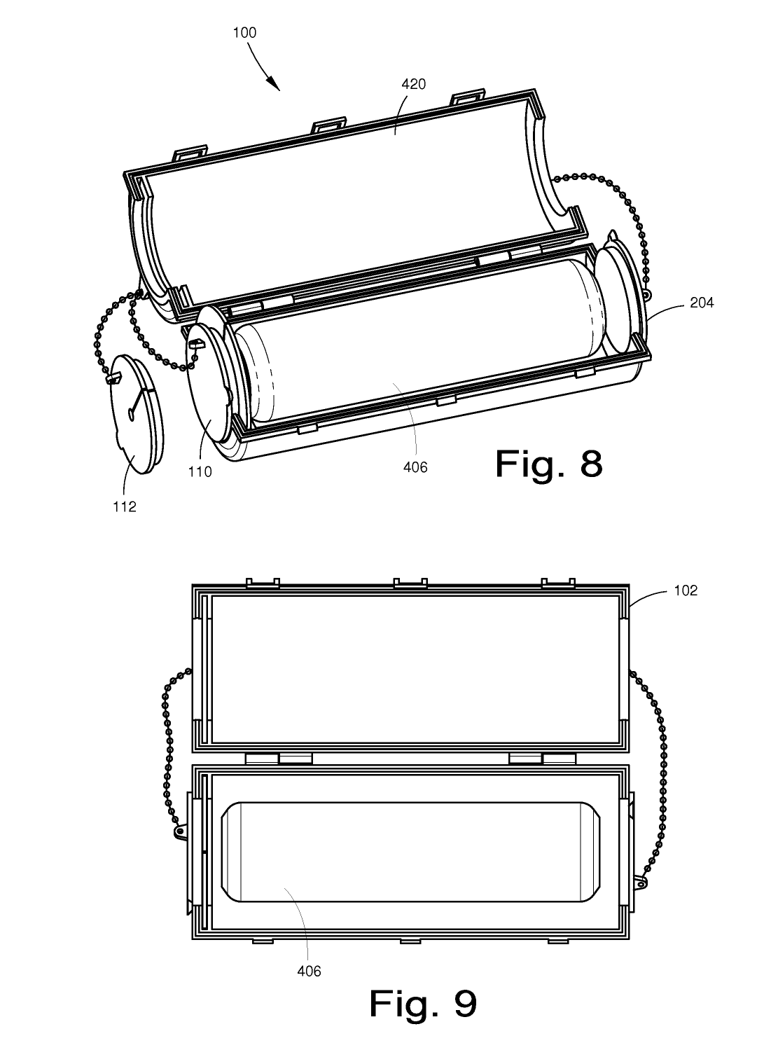

FIG. 8 is a front perspective view of a paint roller stored inside the case in an open position, according to one embodiment. FIG. 8 shows the case element 102 in an open position, with the paint roller 406 remaining within the inner volume of the case element 102, while the roller wheel 702 has been removed from the inner volume of the case element 102. FIG. 8 also shows that the solid cap 110 has been placed in the opening in the first end 111 of the case element 102, so as to close said opening, and the solid cap 204 has been placed in the opening in the second end 113 of the case element 102, so as to close said opening. If said case element 102 is then placed in the closed position, the inner volume of the case element 102 would be substantially hermetically sealed, so as to inhibit or prevent the drying out of a wet paint roller. This would allow a painter to pause during the painting process, store the wet paint roller in the case element, so as to maintain it in a wet status, and then restart painting at a later time with the same paint roller, which has not dried out or otherwise lost moisture.

FIG. 9 is a top view of a paint roller stored inside the case in an open position, according to one embodiment. FIG. 9 shows that the solid cap 110 has been placed in the left hand opening of the case element 102, so as to close said opening, and solid cap 204 has been placed in the right hand opening of the case element 102, so as to close said opening. FIG. 9 also shows that the inner volume of the case element 102 is adapted to comfortably accept the paint roller 406, so as to enclose it. If said case element 102 of FIG. 9 is then placed in the closed position, the inner volume of the case element 102 would be substantially hermetically sealed, so as to inhibit or prevent the drying out of a wet paint roller.

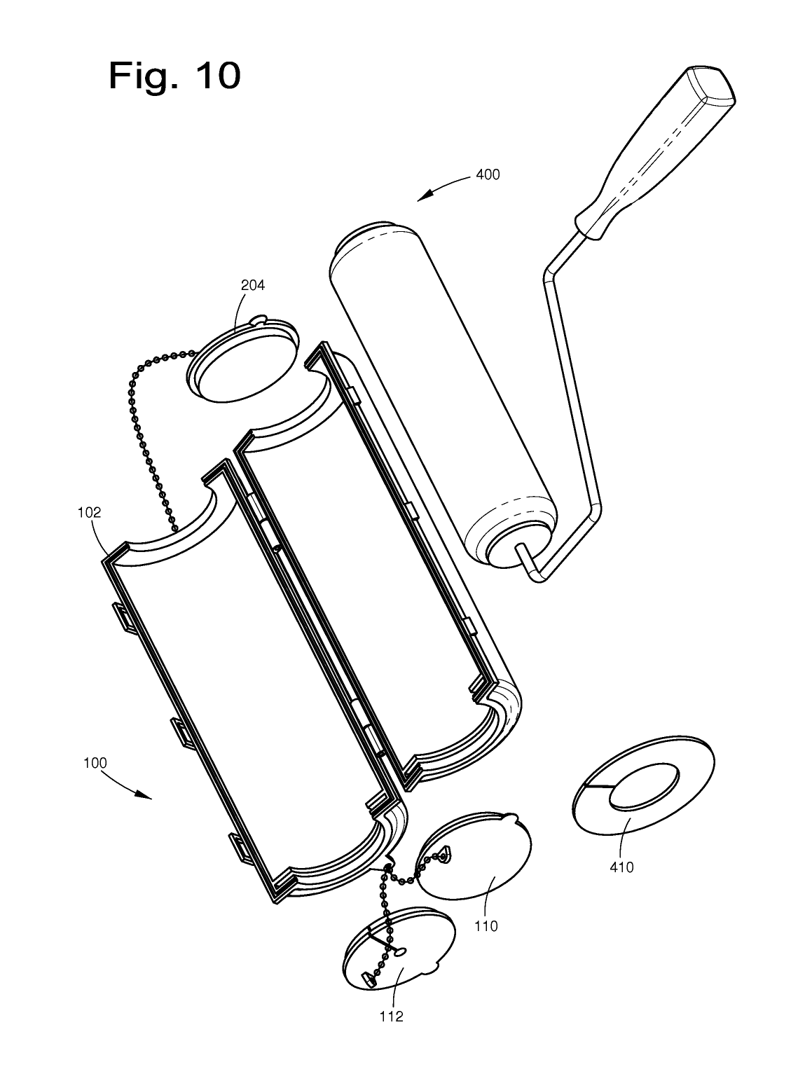

FIG. 10 is a front perspective view of a paint roller outside the case in an open position, according to one embodiment. FIG. 10 shows the assembly 100 in a disassembled state. FIG. 10 shows the top portion 104 and bottom portion 106 of the cylinder or case element 102 is in the open position. FIG. 10 also shows that the left side opening of the case element 102 may be closed or capped with either the solid cap 110 or the slotted cap 112, as described above. The figure also shows that the flat ring 410 may be inserted into a corresponding slot in the case element 102, which ring could be used later to remove the paint roller form the roller tool 400. FIG. 10 also shows that the right side opening of the case element 102 may be closed or capped with the solid cap 204, as described above. In one embodiment, the case element and various other components of the assembly 100 may be composed of plastic, rubber, polymers, metal or any combination of the foregoing. With regard to plastics, the case element and various other components of the assembly 100 may be composed of polyester, polyethylene terephthalate, polyethylene, HDPE, PVC, PVDC, LDPE, polypropylene, HIPS, polyamides, PE/ABS, polycarbonate, PC/ABS, polyurethane, or any combination of the foregoing.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A case for storing a paint roller, comprising:
a case element having a first section hingedly connected to a second section, wherein the first section comprises a half tube shaped body and the second section comprises a half tube shaped body, wherein in a closed position the case element defines a tubular shaped body having a first end opposing a second end and wherein each end has an opening, wherein the case element is adapted for receiving a paint roller when the case element is in an open position, and wherein the case element is adapted for enclosing a paint roller when the case element is in a closed position;
a first end cap for closing the opening of the first end of the case element when the case element is in the closed position;
a second end cap for closing the opening of the second end of the case element when the case element is in the closed position;
a ring having a planar cylindrical body defining an aperture and having a slit spanning from a position on the perimeter of the body of the ring to the ring aperture, wherein the ring is adapted to be received by a groove along the body of the case element, wherein the slit is adapted for allowing an arm of a rolling tool to pass into the ring aperture, and wherein the ring aperture is adapted for allowing a rolling tool to be pulled out of the case element while retaining a paint roller inside the case element when the case element is in the closed position; and,
a disc for closing the opening of the first end of the case element, wherein the disc comprises a first cylindrical body comprising a material having rigid properties and comprising a top surface opposing a bottom surface, and a second cylindrical body comprising a material having resilient properties and coupled to the bottom surface of the first cylindrical body, wherein the second cylindrical body is adapted to be inserted into and to plug the opening of the first end of the case element when the case element is in the closed position, wherein the first and second cylindrical bodies have an aperture and a slit spanning from the aperture to a position on the perimeter of the disc, wherein the slit is adapted for allowing an arm of a rolling tool to pass into the aperture.

2. The case of claim 1, wherein the body of the first section of the case element further defines a first side edge opposing a second side edge, and wherein the body of the second section of the case element further defines a first side edge opposing a second side edge, wherein the first side edges are hingedly connected, and wherein the second side edges comprise a locking device for coupling the second side edges to each other.

3. The case of claim 1, wherein the first end cap comprises a first cylindrical planar body comprising a material having rigid properties and comprising a top surface opposing a bottom surface, and a second cylindrical body comprising a material having resilient properties and coupled to the bottom surface of the first cylindrical body, and wherein the second cylindrical body is adapted to be inserted into and to plug the opening of the first end of the case element.

4. The case of claim 3, wherein the second end cap comprises a first cylindrical planar body comprising a material having rigid properties and comprising a top surface opposing a bottom surface, and a second cylindrical body comprising a material having resilient properties and coupled to the bottom surface of the first cylindrical body, and wherein the second cylindrical body and is adapted to be inserted into and to plug the opening of the second end of the case element.

5. The case of claim 1, wherein the case element comprises material having rigid properties.

6. The case of claim 2, wherein the locking device comprises at least one wedge shaped body along the second side edge of the first section and at least one corresponding u-shaped body on the second side edge of the second section, wherein each u-shaped body is adapted for catching and retaining a corresponding wedge so as to maintain the case element in the closed position.

7. The case of claim 6, wherein each wedge is adapted such that when the case element is in the closed position an inward force acting upon each wedge shaped body causes the wedge to move inward such that the corresponding u-shaped body can pass the wedge and allow the case element to move to the open position.

8. The case of claim 1, wherein the case is significantly air tight when the case element is in the closed position and the openings of each end of the case element are plugged.

9. A case for storing a paint roller comprising:
a case element having a first section hingedly connected to a second section, wherein the first section comprises a half tube shaped body and the second section comprises a half tube shaped body, wherein in a closed position the case element defines a tubular shaped body having a first end opposing a second end and wherein each end has an opening, and wherein the case element is adapted for receiving a paint roller when the case element is in an open position, and wherein the case element is adapted for enclosing a paint roller when the case element is in a closed position, and wherein the case element further comprises three wedge shaped bodies along a side edge of the first section and three aligning u-shaped bodies on a side edge of the second section, and wherein the u-shaped bodies are adapted for catching and retaining the wedge shaped bodies so as to maintain the case element in the closed position;
a first end cap for closing the opening of the first end of the case element when in the closed position, wherein the first end cap comprises a first cylindrical planar body comprising a material having rigid properties and comprising a top surface opposing a bottom surface, and a second cylindrical body comprising a material having resilient properties and coupled to the bottom surface of the first cylindrical body, and wherein the second cylindrical body is adapted to be inserted into and to and plug the opening of the first end of the case element;
a second end cap for closing the opening of the second end of the case element when in the closed position, wherein the second end cap comprises a first cylindrical planar body comprising a material having rigid properties and comprising a top surface opposing a bottom surface, and a second cylindrical body comprising a material having resilient properties and coupled to the bottom surface of the first cylindrical body, and wherein the second cylindrical body is adapted to be inserted into and to plug the opening of the second end of the case element;
a ring having a planar cylindrical body defining an aperture and having a slit spanning from a position on the perimeter of the body of the ring to the ring aperture, wherein the ring is adapted to be received by a groove along the body of the case element, wherein the slit is adapted for allowing an arm of a rolling tool to pass into the ring aperture, and wherein the ring aperture is adapted for allowing a rolling tool to be pulled out of the case element while retaining a paint roller inside the case element when the case element is in the closed position; and,
a disc for closing the opening of the first end of the case element, wherein the disc comprises a first cylindrical body comprising a material having rigid properties and comprising a top surface opposing a bottom surface, and a second cylindrical body comprising a material having resilient properties and coupled to the bottom surface of the first cylindrical body, wherein the second cylindrical body is adapted to be inserted into and to plug the opening of the first end of the case element, wherein the disc has an aperture and a slit spanning from the aperture to a position on the perimeter of the disc, and wherein the slit is adapted for allowing an arm of a rolling tool to pass into the aperture.

10. The case of claim 9, wherein each of the wedge shaped bodies is adapted such that when the case element is in the closed position an inward force acting upon each of the wedge shaped bodies causes the body of such wedge to move inward so that the corresponding u-shaped body can pass the wedge and allow the case element to move to the open position.

11. The case of claim 9, wherein the end caps and disc are coupled to an eyelet on the body of the tubular case element by a cord attached to an eyelet on each of the end caps.

12. The case of claim 9, wherein the case element comprises material having rigid properties.

13. The case of claim 12, wherein the case is significantly air tight when the case element is in the closed position and the openings of each ends of the case element are plugged.

14. A case for storing a wet paint roller so as to maintain the paint roller wet, the case comprising:
a cylindrical case element including means for opening the case element to allow access to an inner volume of the case element, the case element adapted for enclosing a paint roller attached to a roller tool;
a circular opening in one end of the cylindrical case element, the circular opening adapted to allow a roller tool to extend from the case element when in a closed position, and the circular opening further adapted to allow removal of the roller tool from the case element in the closed position, while allowing the paint roller to remain within the case element;
a solid cap for closing the circular opening when the case element is in the closed position and encloses solely a paint roller, so as to substantially hermetically seal the inner volume of the case element; and
a slotted cap for closing the circular opening when the case element is in the closed position and the roller tool extends from the case element through a slot in the slotted cap, so as to substantially hermetically seal the inner volume of the case element.

15. The case of claim 14, wherein the case element comprises a first section hingedly connected to a second section, wherein the first section comprises a half tube shaped body and the second section comprises a half tube shaped body, wherein in a closed position the case element defines a tubular shaped body, and wherein the case element is adapted for receiving a paint roller when the case element is in an open position, and wherein the case element is adapted for enclosing a paint roller when the case element is in a closed position.

16. The case of claim 14, wherein the first section of the case element further defines a first side edge opposing a second side edge, and wherein the second section of the case element further defines a first side edge opposing a second side edge, wherein the first side edges are hingedly connected, and wherein the second side edges comprise a fastener for coupling the second side edges to each other.

17. The case of claim 14, wherein the fasteners comprises at least one wedge shaped body along the second side edge of the first section and an aligning u-shaped body on the second side edge of the second section, wherein each u-shaped body is adapted for catching and retaining a corresponding wedge shaped body so as to maintain the case element in the closed position.

18. The case of claim 17, wherein each wedge is adapted such that when the case element is in the closed position an inward force acting upon each wedge shaped body causes the body of such wedge to move inward so that the corresponding u-shaped body can pass the wedge and allow the case element to move to the open position.

19. The case from claim 14, wherein the solid cap comprises an outward facing surface comprised of a rigid plastic material and an inward facing surface comprising a material having resilient properties.

20. The case from claim 14, wherein the slotted cap comprises a disk shaped element having a slot and an aperture in a midpoint of the element, such that the roller tool extends through the aperture, and wherein the slotted cap is comprised of a rubber material.
